(19) United States
(12) Patent Application Publication
(10) Pub. No.: US 2006/0147835 A1
(43) Pub. Date: Jul. 6, 2006

(54) Chemically amplified photoresists and related methods

(76) Inventors: Sook Lee, Seoul (KR); Min-jeong Oh, Metropolitan City (KR); Suk-joo Lee, Yongin-si (JP)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/293,125

(22) Filed: Dec. 5, 2005

(30) Foreign Application Priority Data
Jan. 3, 2005 (KR) 10-2005-0000085

(51) Int. Cl. G03C 1/76

(52) U.S. Cl. 430/270.1

(57) ABSTRACT

A chemically-amplified photoresist composition includes a polymer resin, a photo acid generator (PAG), and a thermal acid generator (TAG), where a thermal deprotection temperature of the polymer resin is greater than an acid generation temperature of the TAG. The photoresist composition may be utilized in a photolithography process which includes subjecting a layer of the photoresist composition to photon exposure which causes the PAG to decompose into acid, subjecting the photon-exposed layer of the photo resist composition to a heat treatment which causes the TAG to decompose into acid, and subjecting the heat-treated layer of photoreist composition to a post-exposure bake (PEB) at a temperature which is greater than the temperature of the heat treatment.

### BACKGROUND OF THE INVENTION

1. Field of the Invention

The present invention generally relates to the manufacture of semiconductor devices, and more particularly, the present invention relates to chemically amplified photoresists and photolithography processes utilized in the manufacture of semiconductor devices.

2. Description of the Related Art

As semiconductor devices become highly integrated, photolithography processes used in the fabrication of such devices must be capable of forming ultra-fine patterns. For example, sub-quarter micron sized patterns are considered necessary in a semiconductor memory device having a capacity exceeding one Gbit. A variety of photolithography light sources having smaller and smaller wavelengths have thus been adopted or proposed. For example, the use of deep ultraviolet (UV) rays of 248 nm from krypton fluoride (KrF) excimer lasers has been utilized since the wavelength thereof is shorter than the more conventional g-line (436 nm) and I-line (365 nm) rays. Also, the argon fluoride (ArF) excimer laser has been more recently been suggested since it exhibits a wavelength (193 nm) which is even shorter than that of the KrF excimer laser. For reasons well understood in the art, smaller wavelengths allow for a reduction in pattern size during photolithography.

However, the relatively low photonic energy attendant the use of smaller wavelength light sources generally requires the use of chemically amplified photoresists which are highly sensitive to photons.

In general, the chemically amplified photoresist includes an acid-labile group which is easily subjected to hydrolysis by an acidic catalyst, and which functions as a dissolution inhibitor. The amplified photoresist also includes a photosensitive acid generator for generating H⁺ (i.e., acid ions). When the chemically amplified photoresist is exposed to light, acid is generated by the photosensitive acid generator. The dissolution inhibitor, which is bound to the backbone of the polymer, is then hydrolyzed by the catalytic reaction of the generated acid, thereby changing the polarity (e.g., solubility) of the polymer. The acid hydrolysis of the polymer by the diffusion of acid produces a pattern having a higher solubility.

The chemical mechanisms underlying the use of chemically amplified photoresists are explained next with reference to FIG. 1. Referring to this figure, in its initial state the chemically amplified photoresist 101 includes a solution of a photo acid generator (PAG) and a polymer resin having insoluble (INSOL) side chains. In photolithography, the photoresist is exposed to photon energy (typically through a mask pattern) which causes the PAG to decompose and generate acid ions as depicted at reference number 102 of FIG. 1. Then, after exposure, the chemically amplified photoresist is subjected to a thermal treatment known as “post exposure bake” (PEB). The PEB causes the acid ions to attack the side chains of the polymer as depicted by reference number 103a of FIG. 1. In this process, know as “deprotection”, the acid ions react with “blocking molecules” on the side chains, rendering the polymer soluble (SOL) at the deprotected side chains. In addition, as depicted by reference number 103b of FIG. 1, the reaction results in the regeneration of additional acid, which reacts with other side chains of polymer resin. The end result is a deprotected resist which is soluble in a developer solution.

As explained below, “Line Edge Roughness” (LER) presents a serious challenge to the effective use of chemically amplified photoresists, particularly as the critical dimension of resist patterns shrinks below the 100 nm range.

Reference is made to FIGS. 2A through 2C. LER is a term of art that generally denote the jaggedness, striations and/or rippling present at the sidewalls of a photoresist pattern and a subsequently etched feature. FIG. 2A is an SEM micrographic image of a photoresist pattern which clearly shows LER at the sidewalls of the pattern. Technically speaking, as illustrated by reference number 201 of FIG. 2B, LER represents the positional variation of each sidewall relative to an ideally formed and perfectly straight sidewall. A related term of art is “line width roughness” (LWR) which, as shown by reference number 202 of FIG. 2C, represents variations in the width of the photoresist pattern relative to an ideally formed pattern.

The severity of LER ranges from the cosmetically undesirable variety which appears in SEM micrographic images, to the yield-degrading variety resulting in unintended void formations, line-to-line leakage, and other defects.

With reduced critical dimensions (CD), LER is becoming an increasing large fraction of the overall CD tolerance budget. As such, there exists a demand for chemically amplified photoresists which are capable of use during photolithography to form features having reduced LER.

### SUMMARY OF THE INVENTION

According to an aspect of the present invention, a chemically-amplified photoresist composition is provided which includes a polymer resin, a photo acid generator (PAG), and a thermal acid generator (TAG), where a thermal deprotection temperature of the polymer resin is greater than an acid generation temperature of the TAG.

According to another aspect of the present invention, a photoresist composition is provided which includes a polymer resin, a photo acid generator (PAG), and a thermal acid generator (TAG), wherein the TAG comprises aliphatic or alicyclic compounds.

According to still another aspect of the present invention, a photolithography method is provided which includes forming a layer of a photoresist composition including a polymer resin, a photo acid generator (PAG), and a thermal acid generator (TAG), where the TAG comprises an aliphatic or alicyclic compound, subjecting the layer of photoresist composition to photon exposure which causes the PAG to decompose into acid, subjecting the photon-exposed layer of photo resist composition to a heat treatment which causes the TAG to decompose into acid, and subjecting the heat-treated layer of photoreist composition to a post-exposure bake (PEB) at a temperature which is greater than a temperature of the heat treatment.

### BRIEF DESCRIPTION OF THE DRAWINGS

The above and other aspects and features of the invention will become readily apparent from the detailed description that follows, with reference to the accompanying drawings, in which:

FIG. 1 is a flow diagram for explaining the chemical mechanisms associated with the use of a conventional chemically amplified photoresist;

FIGS. 2A through 2C are views for explaining line edge roughness (LER) resulting from conventional photolithography processes;

FIGS. 3 and 4 are schematic views for use in explaining possible causes of LER;

FIG. 5 is a schematic flow diagram from explaining chemical mechanisms associated with the use of a chemically amplified photoresist composition according to one or more embodiments of the present invention; and

FIG. 6 illustrates the reaction mechanisms according to one or more embodiments of the present invention.

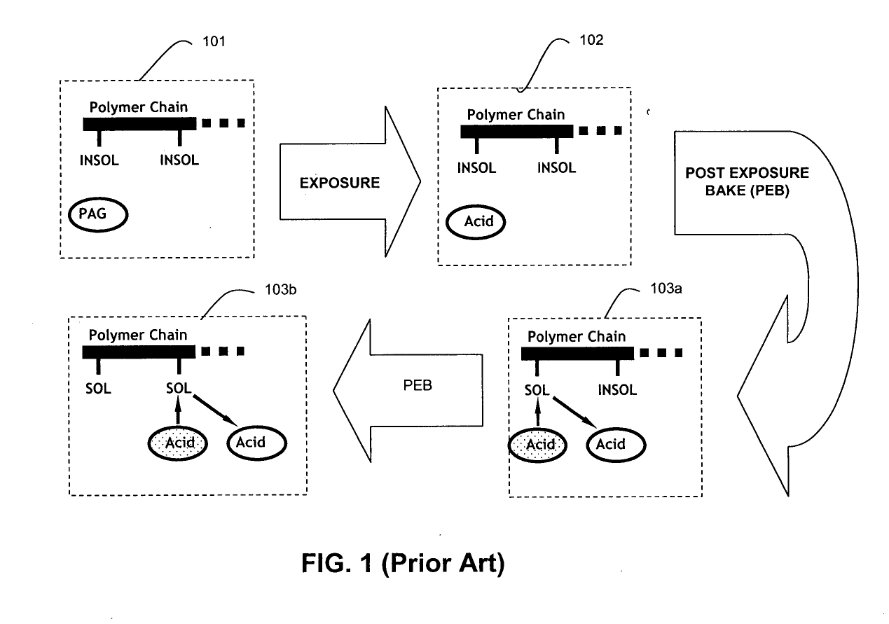

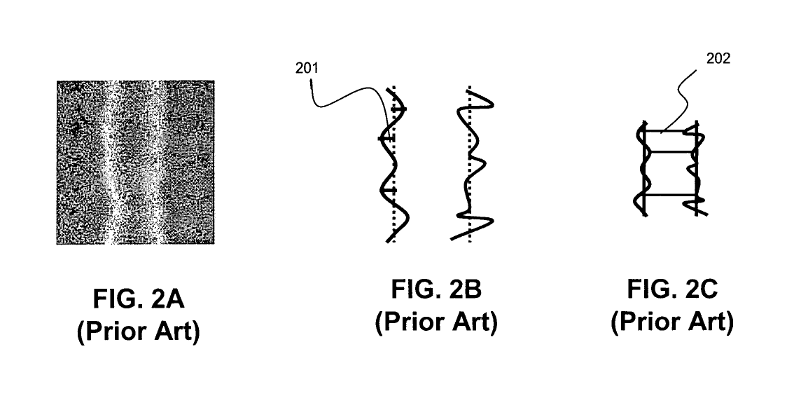

### DETAILED DESCRIPTION OF PREFERRED EMBODIMENTS

The origins of Line Edge Roughness (LER) are not entirely understood, but many factors are thought to contribute. Image fluctuations, development process characteristics, and photoresist characteristics can all play a part in the formation of LER. This invention is primarily directed to the use of and material characteristics of chemically amplified photoresists as a way to achieve improved LER of etched features.

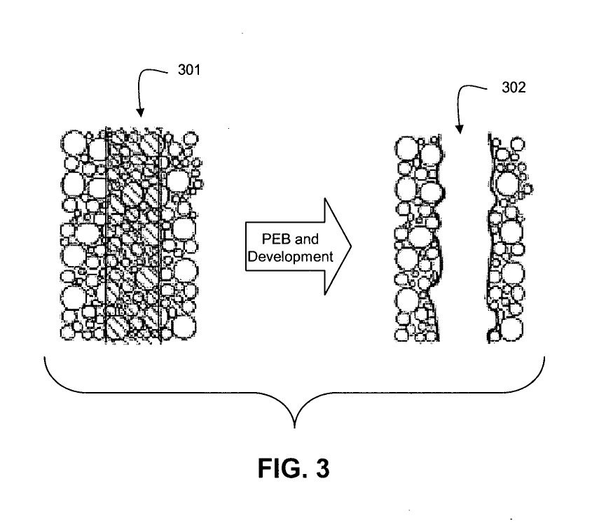

Without being limited by theory, one possible cause of LER is the “jagged” segregation line between protected and deprotected polymers after post exposure bake (PEB) of the photoresist layer. This is schematically illustrated in FIG. 3 where reference number 301 denotes an exposure region of the photoresist layer, and where reference number 302 denotes a region of the photoresist removed after development. Chemically amplified photoresists tend to form spongy or roughened sidewalls. That is, the photoacid diffusion and catalytic reaction form coiled polymer chains or polymer aggregates, leading to a roughened sidewall when developed. The developed resist is nonhomogeneous and is likely to be further roughened by the physical and chemical actions of subsequent plasma etching process.

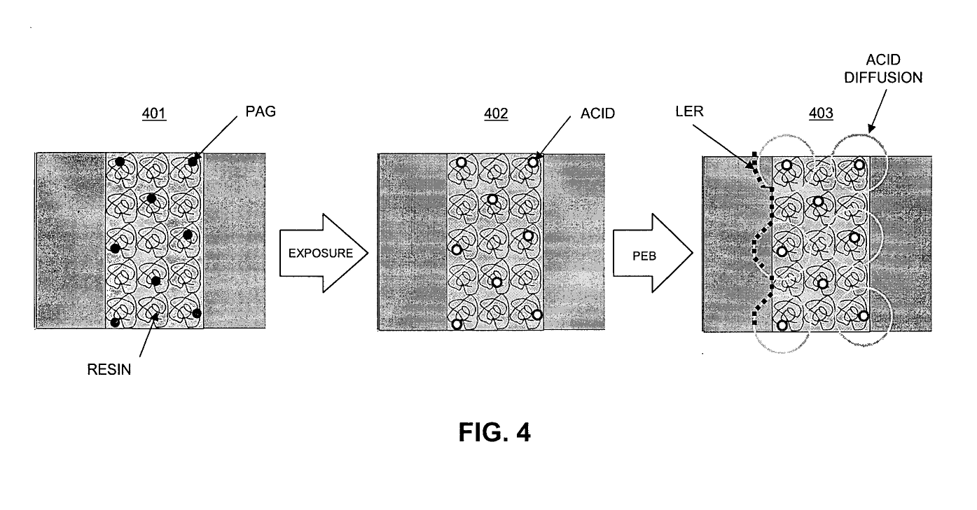

It is generally known that increasing the amount of PAG relative to that of the polymer resin disadvantageously reduces the transmittance of most chemically amplified photoresists. As discussed below with reference to FIG. 4, this limitation on the quantity of PAG can contribute to LER by limiting the uniformity of post-exposure acid within the photoresist.

Reference number 401 of FIG. 4 schematically illustrates a state where the chemically amplified photoresist is coated on an underlying substrate. As illustrated, the PAG is dispersed in the polymer resin of the photoresist. After exposure, the chemically amplified photoresist is in a state illustrated by reference number 402 of FIG. 4. That is, the PAG has been converted to acid which is dispersed in the polymer resin of the photoresist. Finally, during PEB, the acid is diffused to render the photoresist soluble where the polymer reacts with the diffused acid. This state is schematically shown at reference number 403 of FIG. 4. As illustrated by the dashed line at 403 of FIG. 4, LER can result from the lack of sufficient acid within the resin of the photoresist. That is, the acid diffusion resulting from PEB is non-uniform due to an overall shortage of post-exposure acid within the photoresist.

It would thus be desirable to increase the amount of PAG in the photoresist to enhance the uniformity of the acid diffusion during PEB. However, as mentioned above, an increase in PAG results in a reduction in transmittance for most chemically amplified photoresists. As such, it is generally not feasible to add sufficient PAG to significantly reduce LER.

To overcome this problem, according to embodiments of the present invention, a component referred to here as a “thermal acid generator” (TAG) is additionally introduced into the photoresist composition. Preferrably, but not necessarily, the photoresist composition is subjected to a low temperature bake prior to PEG. The low temperature bake causes the TAG to decompose and catalyze with the acid of the PAG to thereby generate a relative large amount of acid in the exposed portion of the photoresist. The relatively high concentration of acid enhances the uniformity of acid diffusion during PEB, which in turn improves LER.

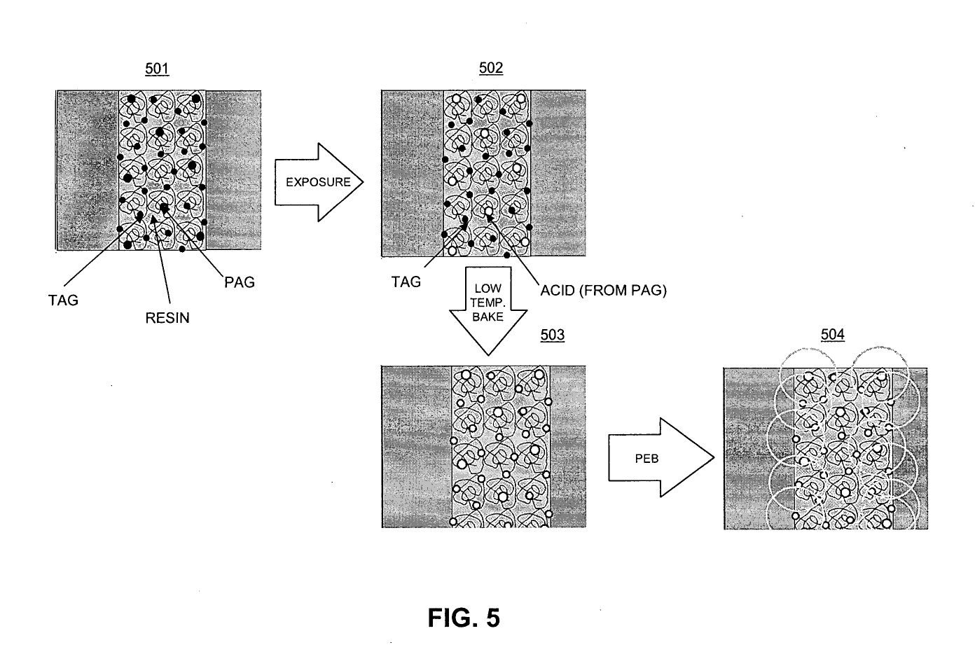

Reference is now made to FIG. 5 for a description of concepts underlying embodiments of the present invention. It should be noted, however, that FIG. 5 is presented for illustrative purposes only, and that the invention is not necessarily limited by FIG. 5 and the discussion related thereto.

Reference number 501 of FIG. 5 schematically illustrates an initial state of the chemically amplified photoresist after being coated over a substrate. As shown, the photoresist includes PAG and TAG dispersed throughout a polymer resin. After exposure, the chemically amplified photoresist is in a state illustrated by reference number 502 of FIG. 5. In this state, the PAG has been converted to acid which is dispersed in the polymer resin of the photoresist. Note here that the TAG remains within the resin at this time. At reference number 503 of FIG. 5, the photoresist has been subjected to a low temperature bake which is generally performed at a temperature which is less than that of the PEB. The low temperature bake causes the TAG to become deprotected and catalyze with the acid of the PAG to thereby generate a relatively large amount of acid in the exposed portion of the photoresist. The combined acid from the TAG and PAG is then diffused by action of the PEB process as generally illustrated by reference number 504 of FIG. 5. As is schematically shown, the large quantity of acid resulting form the TAG and PAG of the photoresist improves the uniformity of acid diffusion during PEB. The improved uniformity of acid diffusion allows for improved LER.

A chemically-amplified photoresist composition according to an embodiment of the present invention thus includes at least a polymer resin, a photo acid generator (PAG), and a thermal acid generator (TAG), where a thermal deprotection temperature of the polymer resin is greater than an acid generation temperature of the TAG. Herein, the phrase “thermal deprotection temperature” is the temperature at which post-exposure acid contained in the photoresist diffuses and causes deprotection of the side-chains within the polymer resin. The PEB temperature of a photolithograpy process will generally equal or exceed the thermal deprotection temperature of the polymer resin. The phrase “acid generation temperature” is the temperature at which the TAG decomposes into an acid. As stated previously, the acid generation temperature of the TAG is less than the thermal deprotection temperature of the polymer resin.

The acid generation temperature of the TAG may be room temperature. However, to accelerate the acid-generation time, the acid generation temperature of the TAG is preferably in the range of 23° C. to 140° C., and more preferably in the range of 30° C. to 130° C.

The thermal deprotection temperature of the PAG depends on the PAG material and preferably is in the range of 50° C. to 140° C., and more preferably in the range of 90° C. to 140° C.

The amount of TAG included in the photoresist composition is preferably in the range of 1 to 20 wt % of the polymer resin, and more preferably in the range of 3 to 10 wt % of the polymer resin.

The amount of PAG included in the photoresist composition is preferably in the range of 1 to 30 wt % of the polymer resin, and more preferably in the range of 1 to 5 wt % of the polymer resin.

The choice of polymer resin and PAG of the photoresist composition is not considered to be limited in the context of embodiments of the present invention.

Non-limiting examples of polymer resins which may be utilized in the photoresist composition of embodiments of the invention include:

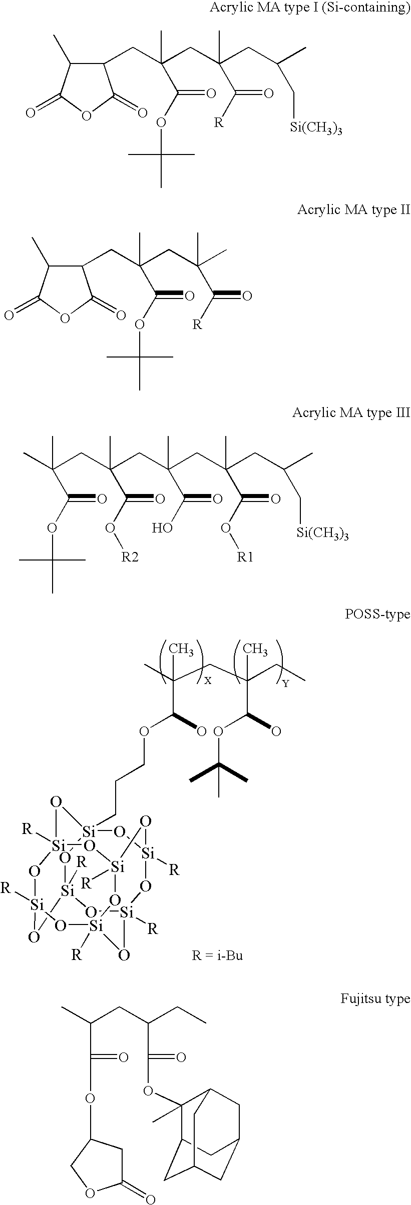

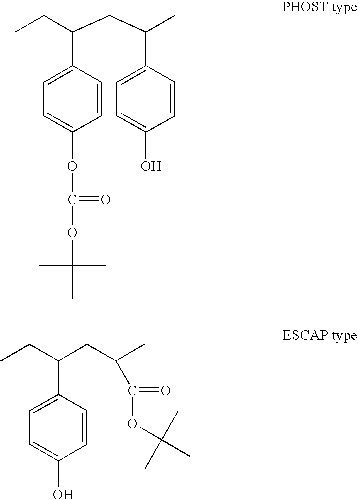

Non-limiting examples of PAG's which may be utilized in the photoresist composition include triarylsulfonium salts, diaryliodonium salts, sulfonates, and mixtures thereof. More specific non-limiting examples include of triphenylsulfonium triflate, N-hydroxysuccinimide, and mixtures thereof.

Favorable characteristics of the TAG material include good transmittance and low-temperature acid generation which catalyzes with acid decomposed from the PAG. The TAG may include aliphatic or alicyclic compounds. Preferably, the TAG includes an ester compound, such as a carbonate ester, sulfonate ester, or phosphate ester having aliphatic compounds or alicyclic compounds as substituents. A non-limiting example of the TAG of embodiments of the present invention is CF₃CF₂CF₂CF₂SO₃R₁, where R1 is an aliphatic or alicyclic compound.

The photoresist composition of embodiments of the present invention may be formed as a solvent mixture, and may also include other components not mentioned previously. For example, the photoresist composition may include an organic base such as triethylamine, triisobutylamine, trioctylamine, triisodecylamine, triethanolamine, diethanolamine and mixtures thereof.

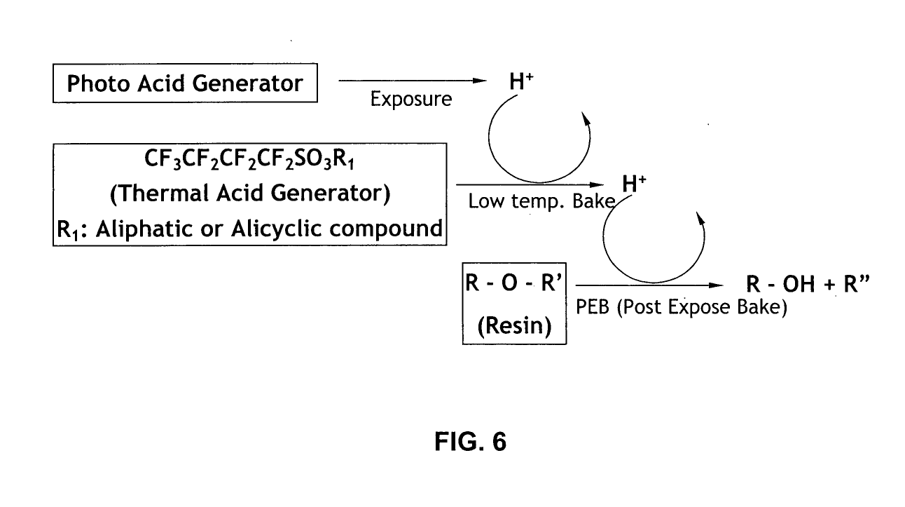

FIG. 6 illustrates the reaction mechanisms according to embodiments of the present invention. As shown, the PAG is exposed to photon energy and decomposed into acid (H+). The TAG is catalyzed by the acid of the PAG and decomposed by the low temperature bake to generate additional acid (H+). Finally, the post exposure bake (PEB) is carried out to cause the acid ions to attack the side chains of the polymer resin R—O—R, resulting in a deprotected resist R—OH—R″ which is soluble in a developer solution.

A photolithography method according to an embodiment of the present invention includes forming a layer of chemically amplified photoresist composition corresponding to one of the previously described embodiments. For example, a layer of a photoresist composition is formed over a substrate which includes a polymer resin, a photo acid generator (PAG), and a thermal acid generator (TAG). The TAG may include an aliphatic or alicyclic compound. Further, the TAG comprises an ester compound, such as carbonate ester, sulfonate ester, and/or phosphate ester. As one specific example, the TAG is CF₃CF₂CF₂CF₂SO₃R₁, where R1 is an aliphatic or alicyclic compound.

The layer of photoresist composition is then subjected to photon exposure which causes the PAG to decompose into acid. The photon exposure may optionally be generated from a krypton fluoride (KrF) excimer laser or an argon fluoride (ArF) excimer layer.

The photon-exposed layer of photoresist composition is then subjected to a heat treatment which causes the TAG to decompose into acid. Without limiting the invention, this heat treatment is preferably conducted in the range of 23° C. to 140° C., and more preferably in the range of 30° C. to 130° C. Also without limiting the invention, the heat treatment may be conducted for about 60 to 90 seconds.

The heat-treated layer of photoreist composition is then subject to a post-exposure bake (PEB) at a temperature which is greater than the temperature of the heat treatment. Again, without limiting the invention, the temperature of the PEB is preferably in the range of 50° C. to 140° C., and more preferably in the range of 90° C. to 140° C. The PEB may, for example, be conducted for about 60 to 90 seconds.

Although the present invention has been described above in connection with the preferred embodiments thereof, the present invention is not so limited. Rather, various changes to and modifications of the preferred embodiments will become readily apparent to those of ordinary skill in the art. Accordingly, the present invention is not limited to the preferred embodiments described above. Rather, the true spirit and scope of the invention is defined by the accompanying claims.

What is claimed is:

1. A chemically-amplified photoresist composition comprising a polymer resin, a photo acid generator (PAG), and a thermal acid generator (TAG), wherein a thermal deprotection temperature of the polymer resin is greater than an acid generation temperature of the TAG.

2. The composition of claim 1, wherein the acid generation temperature of the TAG is in the range of 23° C. to 140° C.

3. The composition of claim 1, wherein the acid generation temperature of the TAG is in the range of 30° C. to 130° C.

4. The composition of claim 1, wherein the thermal deprotection temperature is in the range of 50° C. to 140° C.

5. The composition of claim 1, wherein the thermal deprotection temperature of the PAG is in the range of 90° C. to 140° C.

6. The composition of claim 1, wherein the amount of TAG included in the composition is in the range of 1 to 20 wt % of the polymer resin.

7. The composition of claim 1, wherein the amount of TAG included in the composition is in the range of 3 to 10 wt % of the polymer resin.

8. The composition of claim 1, wherein the amount of PAG included in the composition is in the range of 1 to 30 wt % of the polymer resin.

9. The composition of claim 1, wherein the amount of PAG included in the composition is in the range of 1 to 5 wt % of the polymer resin.

10. The composition of claim 1, wherein the TAG comprises aliphatic or alicyclic compounds.

11. The composition of claim 10, wherein the TAG comprises an ester compound.

12. The composition of claim 11, wherein the ester compound is a carbonate ester, sulfonate ester, or phosphate ester.

13. The composition of claim 1, wherein the TAG is CF₃CF₂CF₂CF₂SO₃R₁, where R1 is an aliphatic or alicyclic compound.

14. A photoresist composition comprising a polymer resin, a photo acid generator (PAG), and a thermal acid generator (TAG), wherein the TAG comprises aliphatic or alicyclic compounds.

15. The composition of claim 14, wherein the amount of TAG included in the composition is in the range of 1 to 20 wt % of the polymer resin.

16. The composition of claim 14, wherein the-amount of TAG included in the composition is in the range of 3 to 10 wt % of the polymer resin.

17. The composition of claim 14, wherein the amount of PAG included in the composition is in the range of 1 to 30 wt % of the polymer resin.

18. The composition of claim 14, wherein the amount of PAG included in the composition is in the range of 1 to 5 wt % of the polymer resin.

19. The composition of claim 14, wherein the TAG comprises an ester compound.

20. The composition of claim 19, wherein the ester compound is a carbonate ester, sulfonate ester, or phosphate ester.

21. The composition of claim 1, wherein the TAG is CF₃CF₂CF₂CF₂SO₃R₁, where R1 is an aliphatic or alicyclic compound.

22. A photolithography method comprising:
forming a layer of a photoresist composition comprising a polymer resin, a photo acid generator (PAG), and a thermal acid generator (TAG), wherein the TAG comprises an aliphatic or alicyclic compound;
subjecting the layer of photoresist composition to photon exposure which causes the PAG to decompose into acid;
subjecting the photon-exposed layer of photo resist composition to a heat treatment which causes the TAG to decompose into acid; and
subjecting the heat-treated layer of photoreist composition to a post-exposure bake (PEB) at a temperature which is greater than the temperature of the heat treatment.

23. The method of claim 22, wherein the temperature of the heat treatment is in the range of 23° C. to 140° C.

24. The method of claim 22, wherein the temperature of the heat treatment is in the range of 30° C. to 130° C.

25. The method of claim 22, wherein the temperature of the PEB is in the range of 50° C. to 140° C.

26. The method of claim 22, wherein the temperature of the PEB is in the range of 90° C. to 140° C.

27. The method of claim 22, wherein the photon exposure is generated from a krypton fluoride (KrF) excimer laser or an argon fluoride (ArF) excimer layer.

28. The method of claim 22, wherein the TAG comprises aliphatic or alicyclic compounds.

29. The method of claim 28, wherein the TAG comprises an ester compound.

30. The method of claim 29, wherein the ester compound is a carbonate ester, sulfonate ester, or phosphate ester.

31. The method of claim 30, wherein the TAG is CF₃CF₂CF₂CF₂SO₃R₁, where R1 is an aliphatic or alicyclic compound.
